(19) United States
(12) Patent Application Publication
(10) Pub. No.: US 2026/0194010 A1
(43) Pub. Date: Jul. 9, 2026

(54) GEARBOX ARRANGEMENT FOR DUAL SPOOL ENGINE ACCESSORIES

(71) Applicant: RTX Corporation, Farmington, CT (US)

(72) Inventors: Thomas E. Clark, Wells, ME (US); Jeffrey T. Morton, Manchester, CT (US)

(21) Appl. No.: 19/551,480

(22) Filed: Feb. 26, 2026

Related U.S. Application Data
(63) Continuation-in-part of application No. 18/774,708, filed on Jul. 16, 2024.

(51) Int. Cl. F02C 7/32; F01D 15/10; F01D 25/20

(52) U.S. Cl. CPC F02C 7/32; F01D 15/10; F01D 25/20; F05D 2260/213; F05D 2260/4031; F05D 2260/98

(57) ABSTRACT

A system includes a turbine engine, a low spool gearbox, and a high spool gearbox. The system also includes a first lubrication system configured to serve the low spool gearbox, and a second lubrication system, independent from the first lubrication system, configured to serve the high spool gearbox. The turbine engine includes a low-pressure spool and a high-pressure spool. The low spool gearbox is disposed within a core compartment of the turbine engine. The low spool gearbox is configured to transfer mechanical power between the low-pressure spool and a first accessory. The high spool gearbox is disposed within the core compartment of the turbine engine. The high spool gearbox is configured to transfer mechanical power between the high-pressure spool and a second accessory.

### CROSS-REFERENCE TO RELATED APPLICATION AND CLAIM OF PRIOIRTY

This application is a continuation-in-part of U.S. Patent Application 18/774,708 filed on July 16, 2024, to which this application claims priority. The above-identified patent application is hereby incorporated by reference in its entirety.

### TECHNICAL FIELD

This disclosure generally relates to turbine engines. More specifically, this disclosure relates to gearbox arrangements for dual spool engine accessories.

### BACKGROUND

A typical turbine engine includes a high-pressure spool (high spool) and a low-pressure spool (low spool). Increasingly in electric and hybrid electric applications, dual spool power extraction and/or power injection may be utilized. In typical applications, mechanical offtakes (such as towershafts) are used from both the high and low spools to either the engine core compartment and/or engine fan cases, and the mechanical offtakes are integrated into a single accessory gearbox. Such applications use a large accessory gearbox to accommodate the dual mechanical offtakes.

### SUMMARY

This disclosure relates to gearbox arrangements for dual spool engine accessories.

In a first embodiment, a system includes a turbine engine, a low spool gearbox, and a high spool gearbox. The system also includes a first lubrication system configured to serve the low spool gearbox, and a second lubrication system, independent from the first lubrication system, configured to serve the high spool gearbox. The turbine engine includes a low-pressure spool and a high-pressure spool. The low spool gearbox is disposed within a core compartment of the turbine engine. The low spool gearbox is configured to transfer mechanical power between the low-pressure spool and a first accessory. The high spool gearbox is disposed within the core compartment of the turbine engine. The high spool gearbox is configured to transfer mechanical power between the high-pressure spool and a second accessory.

Any single one or any combination of the following features may be used with the first embodiment. The system may include a heat exchanger configured to transfer heat between a first fluid of the first lubrication system and a second fluid of the second lubrication system without mixing the first fluid with the second fluid. At least one component of the first lubrication system may be configured to be mechanically powered by the low spool gearbox. At least one component of the second lubrication system may be configured to be mechanically powered by the high spool gearbox. At least one component of the first lubrication system may be configured to be powered independently of the low spool gearbox. At least one component of the second lubrication system may be configured to be powered independently of the high spool gearbox. The system may include at least one generator. The at least one generator may be configured to be mechanically powered by one of the high spool gearbox or the low spool gearbox. At least one component of the first lubrication system may be configured to be electrically powered by the at least one generator. At least one component of the second lubrication system may be configured to be electrically powered by the at least one generator. At least one component of the first lubrication system may be mounted to the low spool gearbox. At least one component of the second lubrication system may be mounted to the high spool gearbox. At least one of the first lubrication system and the second lubrication system may be configured to serve at least one component of the turbine engine while remaining fluidically independent from the other of the first lubrication system and the second lubrication system. At least one of the first lubrication system and the second lubrication system may include a heat exchanger. At least one of the first lubrication system and the second lubrication system may be a coolant system for one or more accessories or components. The system may include an interlink mechanically coupling the low spool gearbox to the high spool gearbox.

In a second embodiment, an apparatus includes a low spool gearbox configured to be disposed within a core of a turbine engine, and a first lubrication system configured to serve the low spool gearbox. The low spool gearbox is configured to transfer mechanical power between a low-pressure spool of the turbine engine and an accessory. The first lubrication system is independent from a second lubrication system configured to serve a high spool gearbox.

Any single one or any combination of the following features may be used with the second embodiment. The first lubrication system may be configured to fluidly couple to a heat exchanger to transfer heat between a first fluid of the first lubrication system and a second fluid of the second lubrication system without mixing the first fluid with the second fluid. At least one component of the first lubrication system may be configured to be mechanically powered by the low spool gearbox. At least one component of the first lubrication system may be configured to be powered independently of the low spool gearbox. The apparatus may include at least one generator. The at least one generator may be configured to be mechanically powered by the low spool gearbox. At least one component of the first lubrication system may be configured to be electrically powered by the at least one generator. At least one component of the first lubrication system may be mounted to the low spool gearbox. The first lubrication system may be configured to serve at least one component of the turbine engine while remaining fluidically independent from the second lubrication system. At least one of the first lubrication system and the second lubrication system may be a coolant system for one or more accessories or components.

In a third embodiment, an apparatus includes a high spool gearbox configured to be disposed within a core of a turbine engine, and a first lubrication system configured to serve the high spool gearbox. The high spool gearbox is configured to transfer mechanical power between a high-pressure spool of the turbine engine and an accessory. The first lubrication system is independent from a second lubrication system configured to serve a low spool gearbox.

Any single one or any combination of the following features may be used with the third embodiment. The first lubrication system may be configured to fluidly couple to a heat exchanger to transfer heat between a first fluid of the first lubrication system and a second fluid of the second lubrication system without mixing the first fluid with the second fluid. At least one component of the first lubrication system may be configured to be mechanically powered by the high spool gearbox. At least one component of the first lubrication system may be configured to be powered independently of the high spool gearbox. The apparatus may include at least one generator. The at least one generator may be configured to be mechanically powered by the high spool gearbox. At least one component of the first lubrication system may be configured to be electrically powered by the at least one generator. At least one component of the first lubrication system may be mounted to the high spool gearbox. The first lubrication system may be configured to serve at least one component of the turbine engine while remaining fluidically independent from the second lubrication system. At least one of the first lubrication system and the second lubrication system may be a coolant system for one or more accessories or components.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIGS. 1A-1F illustrate an example system for dual spool power extraction in accordance with this disclosure;

FIG. 2 illustrates another example system for dual spool power extraction in accordance with this disclosure; and

FIG. 3 illustrates another example system for dual spool power extraction in accordance with this disclosure.

### DETAILED DESCRIPTION

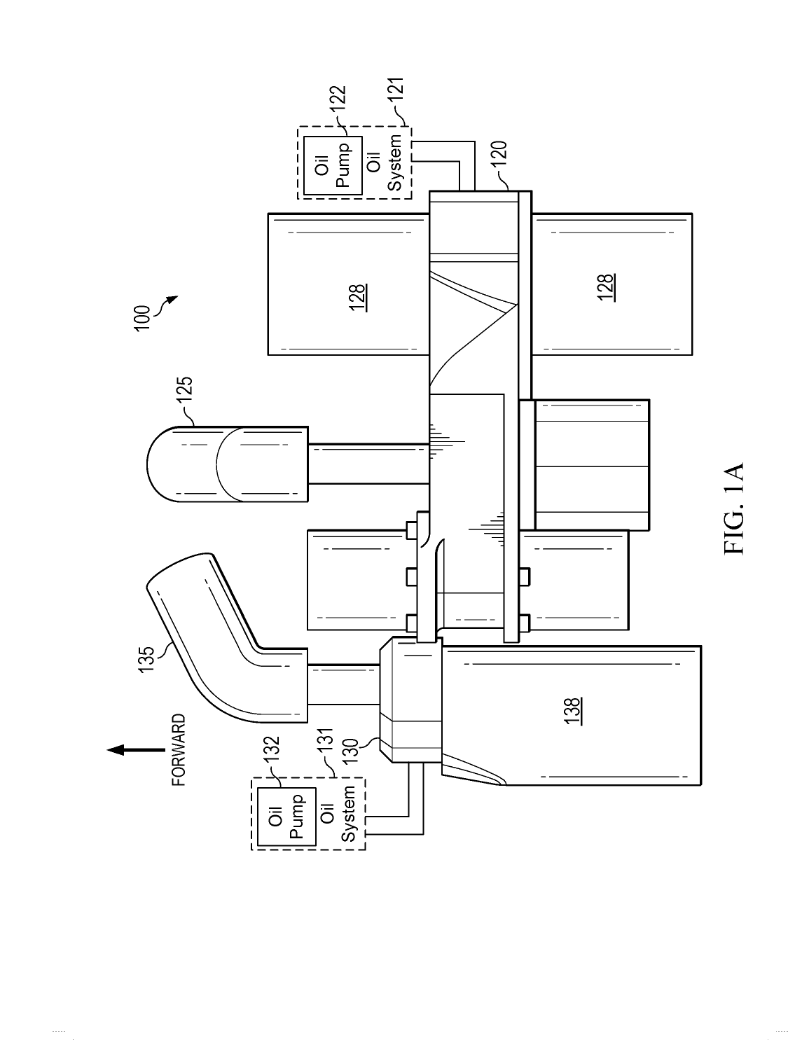

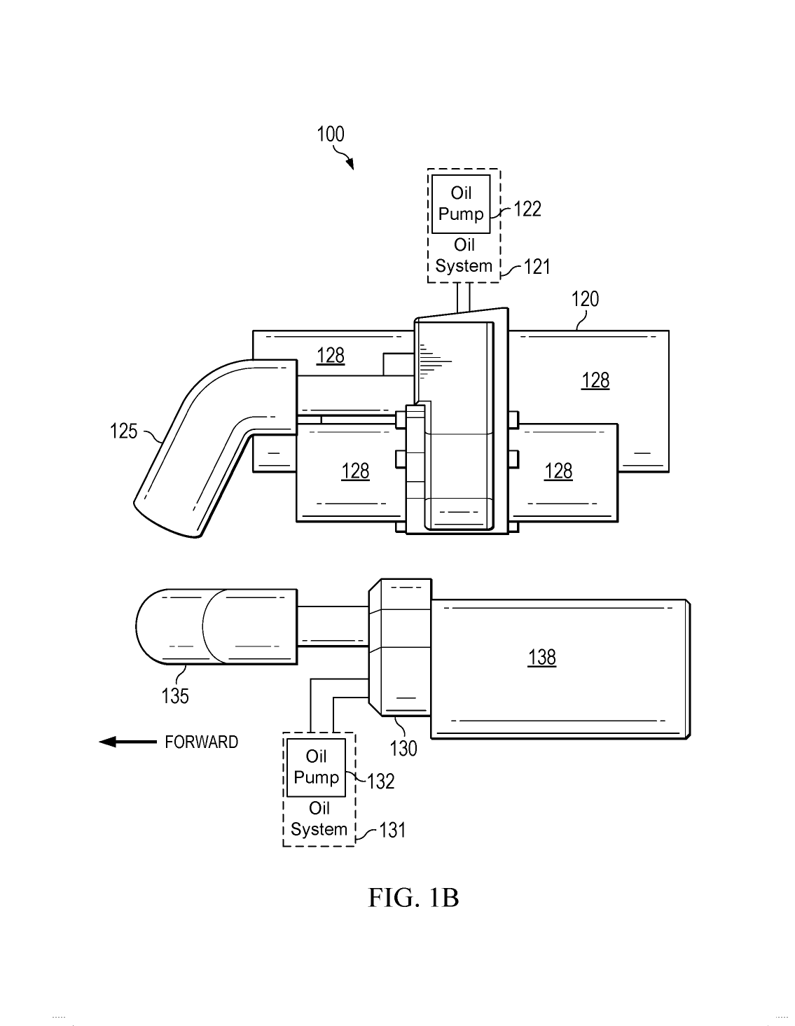

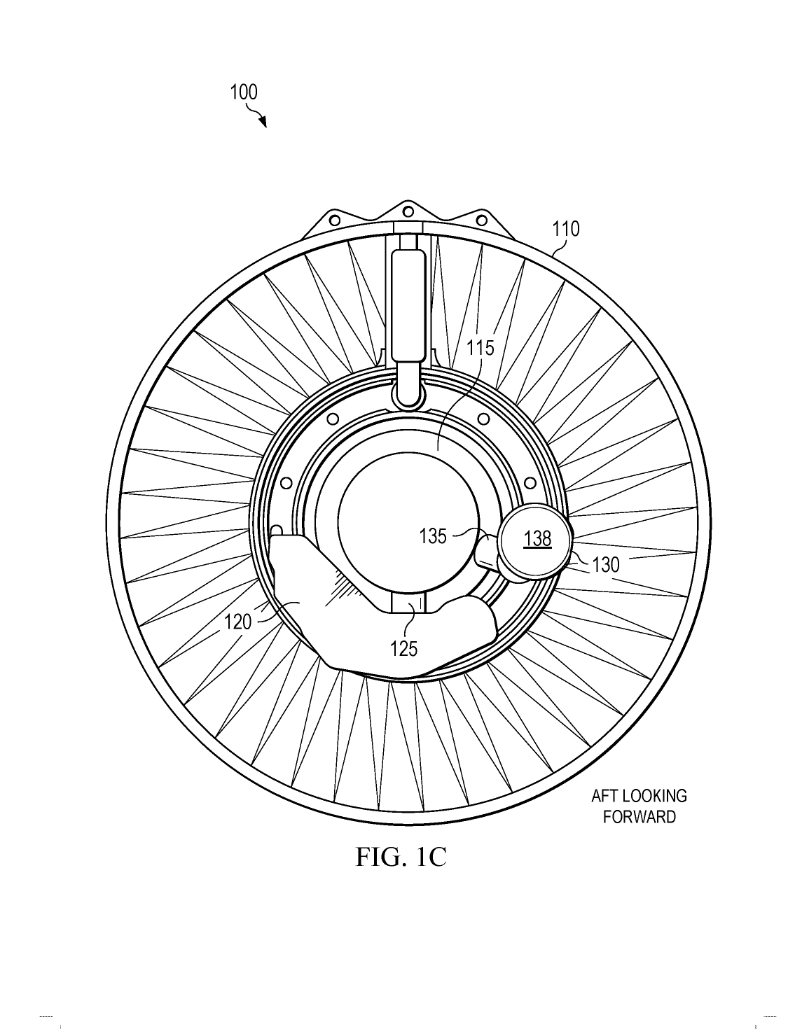

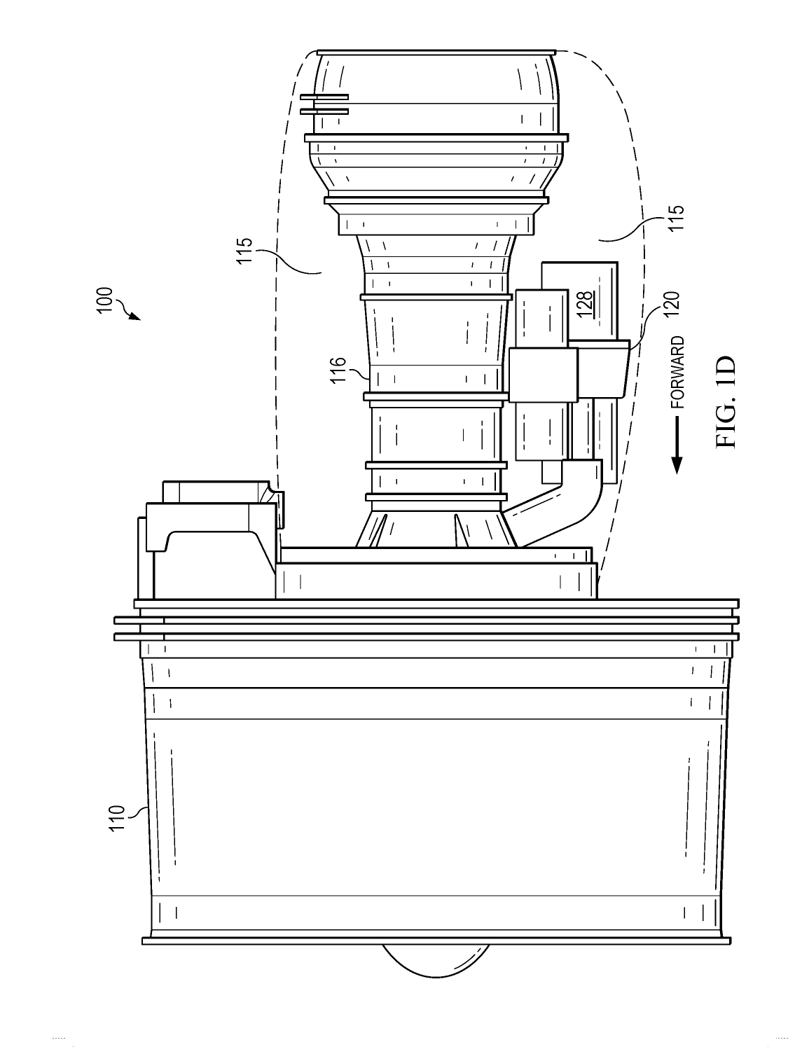

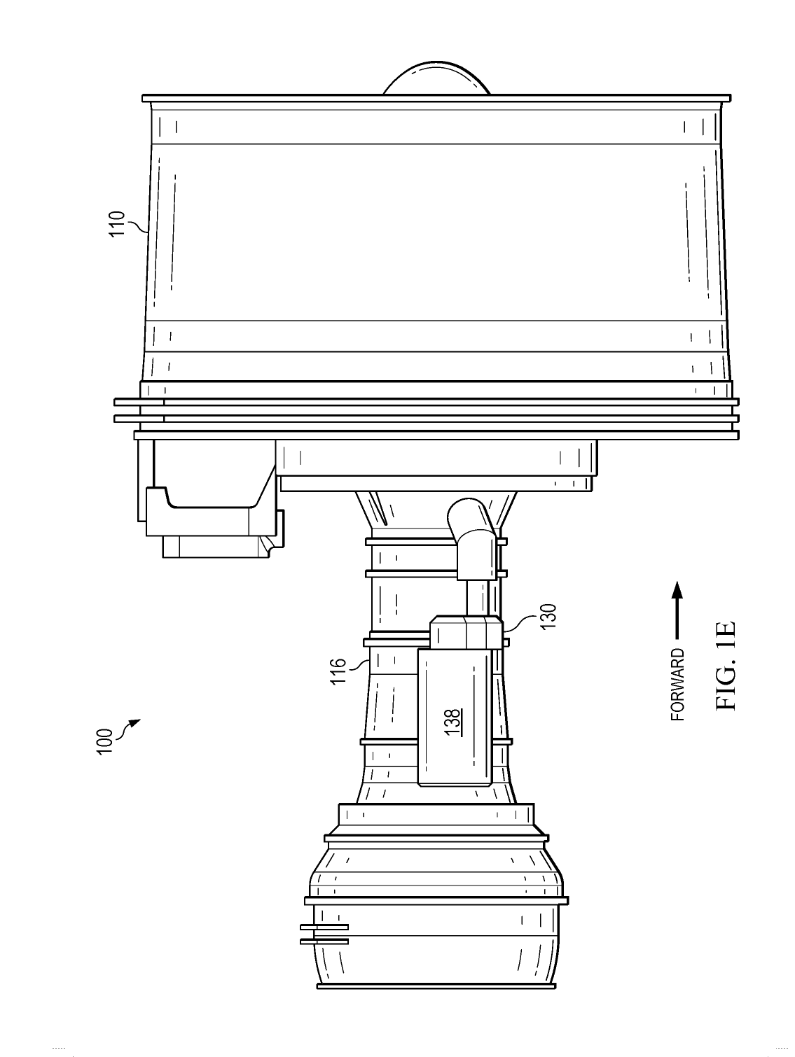

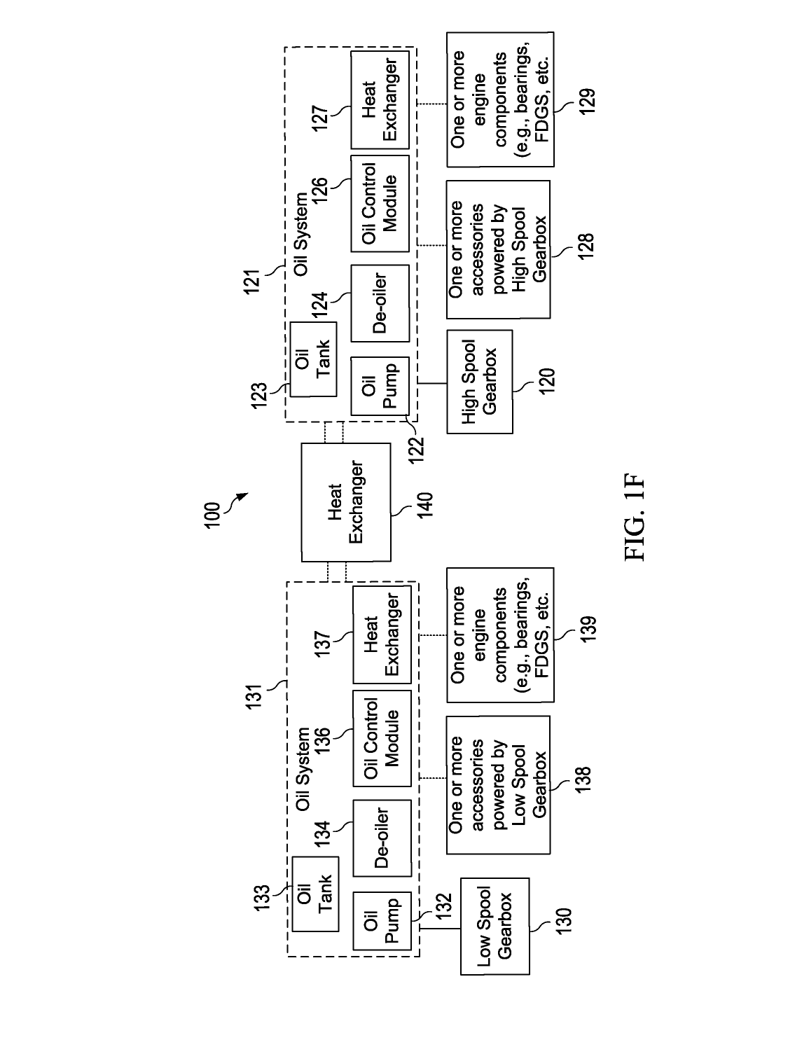

FIGS. 1A through 3, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, dual spool power extraction and/or power injection in a turbine engine may include mechanical offtakes used from both the high and low spools integrated into a single large accessory gearbox. Fan bladeoff (FBO) case load management, accessory maintainability, and gearbox strength may be challenged as a result of the single large accessory gearbox. To overcome these challenges, the present disclosure provides gearbox arrangements for dual spool engine offtakes including two gearboxes. The first gearbox is integrated to a high spool offtake and accessories, and the second gearbox is integrated to a low spool offtake and accessories. The sum of the volumes of the gearboxes is less than a single equivalent gearbox due to optimized spur gear spacing and positional arrangements of the engine accessories. In some embodiments, one or both of the gearboxes are integrated in a manner as to allow the assembly to be removed from the engine core compartment as a single line removable unit (LRU), which enhances engine maintenance and modularity. As an additional benefit, the mass of each gearbox is reduced, reducing the case punch loads observed at the compressor-diffuser case flange during FBO events. Dynamic and engine vibration loads management of each gearbox may be improved relative to a single large gearbox. Furthermore, the dual gearbox arrangement allows for larger overall gearbox installations, where the sum of each gearbox may span more than a 180 degree sector of the engine core compartment if needed. In some embodiments, the first gearbox and the second gearbox may be serviced by independent oil and/or coolant systems. This may provide additional size, weight, and/or placement savings, as the independent oil and coolant systems may be sized proportionally smaller than a single oil and/or coolant system serving both gearboxes. An additional benefit is that a failure of one oil or coolant system will only affect the served gearbox.

FIGS. 1A-1F illustrate an example system 100 for dual spool power extraction in accordance with this disclosure. It should be understood that the various views of FIGS. 1A-1F omit certain components of system 100 for clarity, but that system 100 includes the aggregate of the components illustrated in FIGS. 1A-1F. As shown in FIGS. 1A-1F, system 100 includes a turbine engine 110, a high spool gearbox 120, and a low spool gearbox 130. High spool gearbox 120 and low spool gearbox 130 are disposed within a core compartment 115 of turbine engine 110. Core compartment 115 is the space between an engine core casing 116 of turbine engine 110 and an inner flow surface of an engine nacelle (not shown) of system 100. High spool gearbox 120 is configured to transfer mechanical power between a high-pressure spool of turbine engine 110 and other accessories. Low spool gearbox 130 is configured to transfer mechanical power between a low-pressure spool of turbine engine 110 and other accessories.

FIG. 1A is a bottom looking up view of system 100 where a bottom side of high spool gearbox 120 is predominately visible. From the perspective of FIG. 1C, the bottom of FIG. 1A is a back of system 100.

FIG. 1B is an alternate view of system 100 where a side of low spool gearbox 130 is predominately visible.

It can be seen in FIGS. 1A and 1B that high spool gearbox 120 includes a mechanical offtake 125 which transfers the mechanical power from the high-pressure spool of turbine engine 110 to high spool gearbox 120. It can also be seen in FIGS. 1A and 1B that low spool gearbox 130 includes a mechanical offtake 135 which transfers the mechanical power from the high-pressure spool of turbine engine 110 to low spool gearbox 130. The high spool gearbox 120 is fluidly coupled (e.g., via plumbing) to an oil system 121 dedicated to high spool gearbox 120 that includes an oil pump 122. The low spool gearbox 130 is fluidly coupled (e.g., via separate plumbing) to another oil system 131, that is dedicated to low spool gearbox 130, and is separate from oil system 121, and includes a dedicated oil pump 132 separate from oil pump 122.

FIG. 1C is an aft looking forward view of system 100. It can be seen in FIG. 1C that high spool gearbox 120 and low spool gearbox 130 are disposed within the core compartment 115 of turbine engine 110. High spool gearbox 120 and low spool gearbox 130 are arranged such that mechanical offtake 125 and mechanical offtake 135 are positioned at an approximately 70 degree angle from each other with respect to the centerline of turbine engine 110. However, the illustrative example in FIG. 1C is not intended to be so limiting and the mechanical offtakes 125, 135 may be positioned at a greater or lesser angle with respect to one another.

FIG. 1D is a side view of system 100 illustrating the relative position of high spool gearbox 120 within the core compartment 115 of turbine engine 110.

FIG. 1E is a side view of system 100 illustrating the relative position of low spool gearbox 130 within the core compartment 115 of turbine engine 110.

FIG. 1F is a block diagram showing the interaction of various components of system 100. It can be seen in FIG. 1F that, in addition to the oil pump 122, the oil system 121 may also include an oil tank 123, a de-oiler 124, an oil control module 126, and/or a heat exchanger 127. The oil system 121 may also be in fluid communication with one or more accessories 128, and/or one or more engine components 129 of the turbine engine 110 (e.g. bearings, a fan drive gear system [FDGS], etc.) to service (e.g. cool and/or lubricate) the accessories 128 and/or components 129.

It can also be seen in FIG. 1F that, in addition to the oil pump 132, the oil system 131 may also include an oil tank 133, a de-oiler 134, an oil control module 136, and/or a heat exchanger 137. The oil system 131may also be in fluid communication with one or more accessories 138, and/or one or more engine components 139 of the turbine engine 110 (e.g. bearings, a fan drive gear system [FDGS], etc.) to service (e.g. cool and/or lubricate) the accessories 138 and/or components 139.

In some embodiments, the accessories 128 and/or components 129 may represent one or more of the accessories 138 and/or components 139. In embodiments such as these, it should be understood that the oil system 121 remains fluidically independent from the oil system 131.

Optionally, in some embodiments, the oil system 121 and the oil system 131 may be in fluid communication with a heat exchanger 140. In embodiments such as these, heat may be transferred from a fluid of one of the oil systems to a fluid of the other oil system via the heat exchanger 140. However, it should be understood that in embodiments such as these, there is no fluid communication between the oil system 121 and the oil system 131. For example, heat exchanger 140 may be a fluid-fluid heat exchanger, such as an oil-oil heat exchanger.

In some embodiments, either or both of the heat exchangers 127 and 137 may be configured as one or more of a fluid-fluid cooler (such as a fuel-oil cooler and/or an oil-oil cooler, etc.), and/or an air-fluid cooler (such as air-oil cooler and/or an air-liquid coolant cooler, etc.).

While oil systems 121 and 131 are described as oil systems, it should be understood that this is merely for convenience of description. Oil systems 121 and 131 may also represent cooling systems that convey fluids other than or in addition to oil, such as coolant liquids or non-oil-based lubricants. For example, in some embodiments, each of oil systems 121 and 131 may represent stand alone cooling systems, and in some embodiments each of oil systems 121 and 131 may represent combined oil and coolant systems.

In the example of FIGS. 1A-1F, high spool gearbox 120 is configured to interface with at least one accessory 128. That is to say, high spool gearbox 120 is configured to transfer mechanical power between high spool gearbox 120 and the at least one accessory 128. Examples of accessories 128 that may interface with high spool gearbox 120 are transmissions, oil pumps (such as oil pump 122), fuel pumps, hydraulic pumps, electrical generators, hybrid motor/generators, etc. For example, high spool gearbox 120 may transfer mechanical power from the high-pressure spool of turbine engine 110 to a fuel pump. In another example, high spool gearbox 120 may transfer mechanical power from a hybrid motor/generator operating in motor mode to the high-pressure spool of turbine engine 110.

In the example of FIGS. 1A-1F, low spool gearbox 130 is configured to interface with at least one accessory 138. That is to say, low spool gearbox 130 is configured to transfer mechanical power between low spool gearbox 130 and the at least one accessory 138. Examples of accessories 128 that may interface with low spool gearbox 130 are transmissions, oil pumps (such as oil pump 132), fuel pumps, hydraulic pumps, electrical generators, hybrid motor/generators, etc. For example, low spool gearbox 130 may transfer mechanical power from the low-pressure spool of turbine engine 110 to a fuel pump. In another example, low spool gearbox 130 may transfer mechanical power from a hybrid motor/generator operating in motor mode to the low-pressure spool of turbine engine 110. While high spool gearbox 120 and low spool gearbox 130 are shown with a particular arrangement, it should be understood that high spool gearbox 120 and low spool gearbox 130 may have any arrangement depending on particular applications. For example, high spool gearbox 120 and low spool gearbox 130 may be arranged to accommodate various high pressure spool or low pressure spool accessories, or various high voltage and low voltage accessories according to particular applications.

In some embodiments, any of the oil pump 122, the oil tank 123, the de-oiler 124, the oil control module 126, and/or the heat exchanger 127 may be mechanically powered by the high spool gearbox 120. In some embodiments, any of the oil pump 122, the oil tank 123, the de-oiler 124, the oil control module 126, and/or the heat exchanger 127 may be independently powered (e.g., by electrical power). For example, in some embodiments, any of the oil pump 122, the oil tank 123, the de-oiler 124, the oil control module 126, and/or the heat exchanger 127 may be electrically powered by electricity sourced from an accessory 128 (such as a generator) powered by the high spool gearbox 120.

In some embodiments, any of the oil pump 122, the oil tank 123, the de-oiler 124, the oil control module 126, and/or the heat exchanger 127 may be mounted to the high spool gearbox 120. In some embodiments, any of the oil pump 122, the oil tank 123, the de-oiler 124, the oil control module 126, and/or the heat exchanger 127 may be remote from the high spool gearbox 120.

In some embodiments, any of the oil pump 132, the oil tank 133, the de-oiler 134, the oil control module 136, and/or the heat exchanger 137 may be mechanically powered by the low spool gearbox 130. In some embodiments, any of the oil pump 132, the oil tank 133, the de-oiler 134, the oil control module 136, and/or the heat exchanger 137 may be independently powered (e.g., by electrical power). For example, in some embodiments, any of the oil pump 132, the oil tank 133, the de-oiler 134, the oil control module 136, and/or the heat exchanger 137 may be electrically powered by electricity sourced from an accessory 138 (such as a generator) powered by the low spool gearbox 130.

In some embodiments, any of the oil pump 132, the oil tank 133, the de-oiler 134, the oil control module 136, and/or the heat exchanger 137 may be mounted to the low spool gearbox 130. In some embodiments, any of the oil pump 132, the oil tank 133, the de-oiler 134, the oil control module 136, and/or the heat exchanger 137 may be remote from the low spool gearbox 130.

In some embodiments, high spool gearbox 120 may be configured as a line replaceable unit (LRU). In some embodiments, the LRU may include at least one accessory 128 interfaced with high spool gearbox 120 as described herein. In some embodiments, the LRU may include the oil system 121.

In some embodiments, low spool gearbox 130 may be configured as an LRU. In some embodiments, the LRU may include at least one accessory 138 interfaced with low spool gearbox 130 as described herein. In some embodiments, the LRU may include the oil system 131.

Although FIGS. 1A-1F illustrate one example of a system 100 for dual spool power extraction, various changes may be made to FIGS. 1A-1F. For example, turbine engine 110 may include additional spools (such as a mid-pressure spool [mid spool]), and system 100 may include additional gearboxes (such as a mid spool gearbox) configured to transfer mechanical power between the additional spools and the additional gearboxes. Also, while shown here as being disposed at particular position within core compartment 115 of turbine engine 110, high spool gearbox 120 and low spool gearbox 130 may be disposed at any position within core compartment 115. Furthermore, while depicted as an assembly for a ducted turbofan engine, system 100 may be configured as an assembly for a different type of turbine engine, such as a turboshaft engine, or an open rotor gas turbine engine.

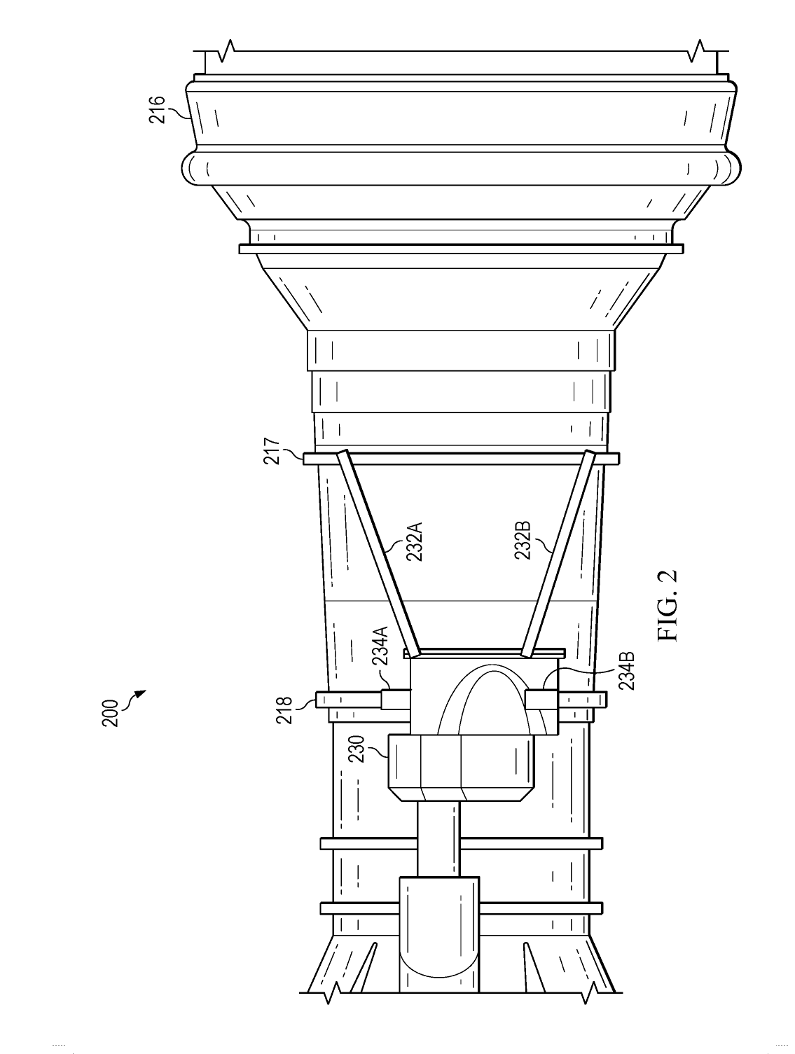

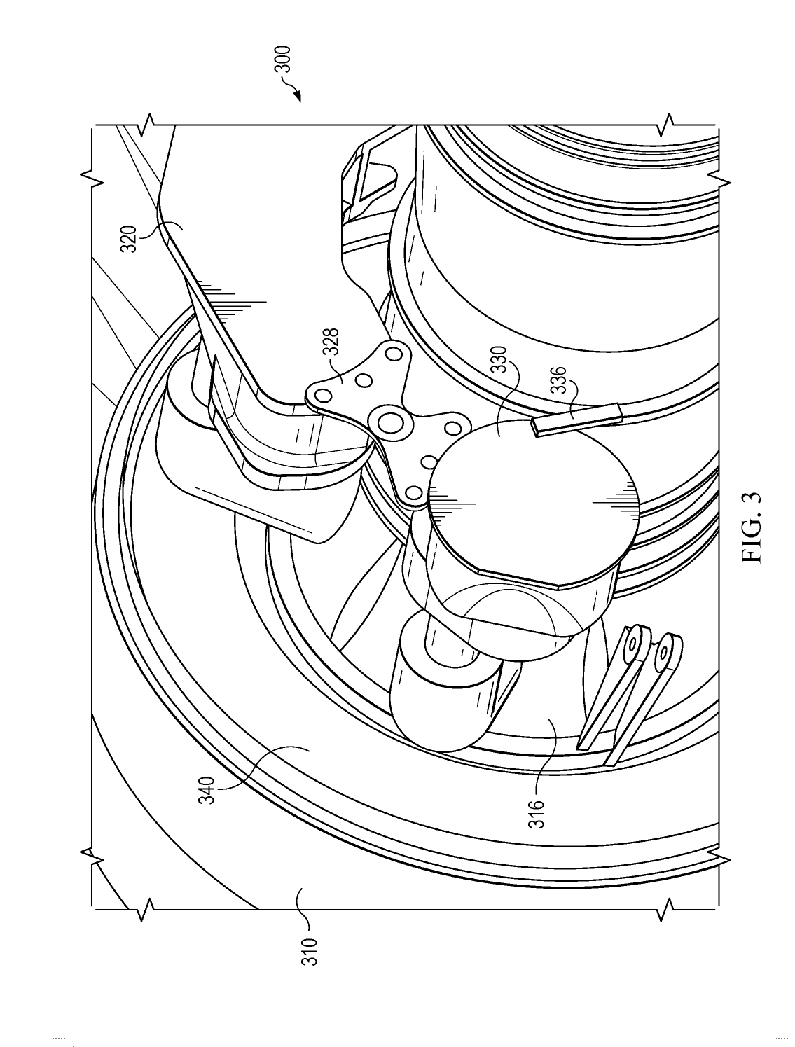

A high spool gearbox and a low spool gearbox may be mechanically coupled (such as mounted) to a turbine engine as well as each other in various ways. The present disclosure provides examples of mechanical coupling between a high spool gearbox, a low spool gearbox, and a turbine engine in FIG. 2 and FIG. 3.

FIG. 2 illustrates an example system 200 for dual spool power extraction in accordance with this disclosure. The example of FIG. 2 shows an engine core casing 216 for a turbine engine. For example, engine core casing 216 may be similar to engine core casing 116 for a turbine engine similar to turbine engine 110 of FIGS. 1A-1F. Additionally, the example of FIG. 2 shows a low spool gearbox 230. Low spool gearbox 230 may be similar to low spool gearbox 130 of FIGS. 1A-1F. While not shown, it should be understood that system 200 may further include a high spool gearbox which may be similar to high spool gearbox 120 of FIGS. 1A-1F.

In the example of FIG. 2, engine core casing 216 includes a first flange 217 and a second flange 218. In some embodiments, low spool gearbox 230 may be mechanically coupled to engine core casing 216 via at least one structural tie, such as a thrust link, a torque link, a rocker link, etc. For example, in FIG. 2, low spool gearbox 230 is mechanically coupled to first flange 217 via thrust links 232A-232B. Thrust links 232A-232B may be vibration isolated. For example, thrust links 232A-232B may include shock mounts that absorb vibration between thrust links 232A-232B and other components of system 200. Low spool gearbox is further mechanically coupled to second flange 218 via rocker links 234A-234B. Rocker links 234A-234B may be vibration isolated. For example, rocker links 234A-234B may include shock mounts that absorb vibration between rocker links 234A-234B and other components of system 200. While not shown, a high spool gearbox may be mechanically coupled to engine core casing 216 in a manner similar as shown regarding low spool gearbox 230. Also, while not shown, it should be understood that low spool gearbox 230 may be mechanically coupled to a high spool gearbox via at least structural tie, similar to the mechanical coupling of low spool gearbox 230 to engine core casing 216. The connection of engine core casing 216, low spool gearbox 230, and additional gearboxes such a high spool gearbox via thrust links, rocker links, torque links, etc. may establish a direction of relative motion of the gearboxes during dynamic events. This may be referred to as a kinematic layout. Examples of dynamic events include high deflection, and high load scenarios such as a bird strike or fan blade out.

Although FIG. 2 illustrates one example of a system 200 for dual spool power extraction, various changes may be made to FIG. 2. For example, the turbine engine of system 200 may include additional spools (such as a mid-pressure spool [mid spool]) and may include additional gearboxes (such as a mid spool gearbox) configured to transfer mechanical power between the additional spools and the additional gearboxes. Additional gearbox(es) may or may not have their own dedicated oil systems or may be serviced (cooled and/or lubricated) by oil system 121 or oil system 131. Also, while shown here as being disposed at a particular position with respect to engine core casing 216, the low spool gearbox 230 may be disposed at any position with respect to engine core casing 216. Furthermore, while depicted as an assembly for a ducted turbofan engine, system 200 may be configured as an assembly for a different type of turbine engine, such as a turboshaft engine, or an open rotor gas turbine engine.

FIG. 3 illustrates an example system 300 for dual spool power extraction in accordance with this disclosure. As shown in FIG. 3, system 300 includes a turbine engine 310, a high spool gearbox 320, and a low spool gearbox 330. Turbine engine 310, high spool gearbox 320, and low spool gearbox 330 may be similar as described regarding turbine engine 110, high spool gearbox 120, and low spool gearbox 130 of FIGS. 1A-1F. In the example of FIG. 3, turbine engine 310 includes an engine core casing 316. Engine core casing 316 may be similar to engine core casing 216 of FIG. 2. Turbine engine 310 also includes a firewall 340.

In the example of FIG. 3, low spool gearbox 330 is mechanically coupled to engine core casing 316 via a torque link 336. Torque link 336 may be vibration isolated. For example, torque link 336 may include shock mounts that absorb vibration between torque link 336 and other components of system 300. While not shown in FIG. 3, it should be understood that high spool gearbox 320 may be similarly coupled to engine core casing 316 via a torque link, and that high spool gearbox 320 and low spool gearbox 330 may be mechanically coupled to engine core casing 316 via a plurality of thrust links similar as described regarding FIG. 2.

In the example of FIG. 3, it can be seen that high spool gearbox 320 and low spool gearbox 330 are disposed aft of firewall 340, and that high spool gearbox 320 is mechanically coupled to low spool gearbox 330 via an interlink 328. Interlink 328 enables close coupling of high spool gearbox 320 and low spool gearbox 330. For example, it can be seen that interlink 328 includes a clearance hole. The clearance hole provides high spool gearbox 320 and a low spool gearbox 330 some freedom to move independently in modest amounts, but to share loads during large magnitudes of motion. In some embodiments, interlink 328 may provide vibration isolation between high spool gearbox 320 and low spool gearbox 330.

Although FIG. 3 illustrates one example of a system 300 for dual spool power extraction, various changes may be made to FIG. 3. For example, turbine engine 310 of system 300 may include additional spools (such as a mid-pressure spool [mid spool]) and may include additional gearboxes (such as a mid spool gearbox) configured to transfer mechanical power between the additional spools and the additional gearboxes. Also, while shown here as being disposed at particular position with respect to engine core casing 316, high spool gearbox 320 and low spool gearbox 330 may be disposed at any position with respect to engine core casing 316. Furthermore, while depicted as an assembly for a ducted turbofan engine, system 300 may be configured as an assembly for a different type of turbine engine, such as a turboshaft engine, or an open rotor gas turbine engine.

It may be advantageous to set forth definitions of certain words and phrases used throughout this patent document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
a turbine engine including a low-pressure spool and a high-pressure spool;
a low spool gearbox disposed within a core compartment of the turbine engine, the low spool gearbox configured to transfer mechanical power between the low-pressure spool and a first accessory;
a first lubrication system configured to serve the low spool gearbox;
a high spool gearbox disposed within the core compartment of the turbine engine, the high spool gearbox configured to transfer mechanical power between the high-pressure spool a second accessory; and
a second lubrication system, independent from the first lubrication system, configured to serve the high spool gearbox.

2. The system of claim 1, further comprising a heat exchanger configured to transfer heat between a first fluid of the first lubrication system and a second fluid of the second lubrication system without mixing the first fluid with the second fluid.

3. The system of claim 1, wherein:
at least one component of the first lubrication system is configured to be mechanically powered by the low spool gearbox; or
at least one component of the second lubrication system is configured to be mechanically powered by the high spool gearbox.

4. The system of claim 1, wherein:
at least one component of the first lubrication system is configured to be powered independently of the low spool gearbox; or
at least one component of the second lubrication system is configured to be powered independently of the high spool gearbox.

5. The system of claim 1, wherein
at least one generator is configured to be mechanically powered by one of the high spool gearbox or the low spool gearbox; and
at least one component of the first lubrication system is configured to be electrically powered by the at least one generator; or
at least one component of the second lubrication system is configured to be electrically powered by the at least one generator.

6. The system of claim 1, wherein:
at least one component of the first lubrication system is mounted to the low spool gearbox; or
at least one component of the second lubrication system is mounted to the high spool gearbox.

7. The system of claim 1, wherein at least one of the first lubrication system and the second lubrication system is configured to serve at least one component of the turbine engine while remaining fluidically independent from the other of the first lubrication system and the second lubrication system.

8. The system of claim 1, wherein:
at least one of the first lubrication system and the second lubrication system comprises a heat exchanger; and
at least one of the first lubrication system and the second lubrication system is a coolant system for one or more accessories or components.

9. The system of claim 1, further comprising an interlink mechanically coupling the low spool gearbox to the high spool gearbox.

10. An apparatus comprising:
a low spool gearbox configured to be disposed within a core compartment of a turbine engine, the low spool gearbox configured to transfer mechanical power between a low-pressure spool of the turbine engine and an accessory; and
a first lubrication system configured to serve the low spool gearbox,
wherein the first lubrication system is independent from a second lubrication system configured to serve a high spool gearbox.

11. The apparatus of claim 10, wherein at least one component of the first lubrication system is configured to be mechanically powered by the low spool gearbox.

12. The apparatus of claim 10, wherein at least one component of the first lubrication system is configured to be powered independently of the low spool gearbox.

13. The apparatus of claim 10, wherein at least one component of the first lubrication system is mounted to the low spool gearbox.

14. The apparatus of claim 10, wherein the first lubrication system is configured to serve at least one component of the turbine engine while remaining fluidically independent from the second lubrication system.

15. An apparatus comprising:
a high spool gearbox configured to be disposed within a core compartment of a turbine engine, the high spool gearbox configured to transfer mechanical power between a high-pressure spool of the turbine engine and an accessory; and
a first lubrication system configured to serve the high spool gearbox,
wherein the first lubrication system is independent from a second lubrication system configured to serve a low spool gearbox.

16. The apparatus of claim 15, wherein the first lubrication system is configured to fluidly couple to a heat exchanger to transfer heat between a first fluid of the first lubrication system and a second fluid of the second lubrication system without mixing the first fluid with the second fluid.

17. The apparatus of claim 15, wherein at least one component of the first lubrication system is configured to be mechanically powered by the high spool gearbox.

18. The apparatus of claim 15, wherein at least one component of the first lubrication system is configured to be powered independently of the high spool gearbox.

19. The apparatus of claim 15, wherein at least one component of the first lubrication system is mounted to the high spool gearbox.

20. The apparatus of claim 15, wherein the first lubrication system is configured to serve a component of the turbine engine while remaining fluidically independent from the second lubrication system.
